(19) United States
(12) Patent Application Publication
(10) Pub. No.: US 2016/0223095 A1
(43) Pub. Date: Aug. 4, 2016

(54) VALVE FOR INFLATABLE DEVICES

(71) Applicant: Sea to Summit Pty Ltd, East Perth (AU)

(72) Inventors: Brendan Michael Sando, East Perth (AU); Paramjeet Singh, East Perth (AU); Roland Tyson, East Perth (AU)

(21) Appl. No.: 15/093,824

(22) Filed: Apr. 8, 2016

Related U.S. Application Data
(63) Continuation of application No. PCT/AU2013/001158, filed on Oct. 8, 2013.

(51) Int. Cl. F16K 15/20; F16K 15/14; F16K 7/17; A47C 27/08

(52) U.S. Cl. CPC F16K 15/20; A47C 27/081; F16K 15/148; F16K 7/17

(57) ABSTRACT

An improved valve for an inflatable device includes a valve port received within an aperture of the inflatable device, a valve seat having fluid apertures provided therein, and a diaphragm connected to the valve seat in a manner that occludes the fluid apertures when fluid is not forced therethrough. The improved valve may, at any time, be manipulated so as to physically remove the valve seat from the valve port to facilitate deflation of the inflatable device and physically insert the valve seat into the valve port to facilitate inflation of the inflatable device.

### FIELD OF THE INVENTION

The invention relates to an improved valve for inflatable devices. The invention is particularly suited to use in inflatable devices such as air mattresses and other inflatable outdoor equipment.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Inflatable devices take many forms. In some cases, such as where the device is inflatable so as to assist its transport, the use of inflating aids (such as pumps) may be limited if available at all. However, regardless of their use, inflation and deflation of the device is typically through the use of a self-sealing valve.

The typical self-sealing inflate valve facilitates movement of fluid in a single direction through an aperture. A flexible diaphragm occludes the aperture in its original position. As fluid is forced into the valve, the diaphragm flexes in the single direction (and thus no longer occlude the aperture so as to allow fluid to enter into the inflatable device). However, the diaphragm is biased or otherwise operates to return to its original position and thus again occlude the aperture and prevent the flow of fluid in a second, opposing direction.

This configuration presents a number of problems:
As the diaphragm is designed to return to its original position, manipulation of the diaphragm in a manner for which it was not readily designed is required to facilitate deflation of the inflatable device; AND
Even when the diaphragm can be manipulated as required, deflation is very slow until there is a significant reduction in air pressure within the inflatable device.

To address these problems some inflatable devices incorporate a separate deflate valve. This creates yet further problems in the form of:
adding to the complexity of operation and manufacturing costs, as well as potentially increasing the height profile of the inflatable device (an undesirable characteristic for transportable inflatable devices).
creating an additional site of potential failure in case of user error; AND
adding a further component increases confusion in finding the correct valve for inflation or deflation specially in active field use situations, such as low light or distress situations.

Attempting to solve the last two problems has seen two-way valves introduced in place of the self-sealing inflate valve. However, such valves typically exacerbate the first problems mentioned above. In particular, two-way valves require mechanical contrivances, such as switches, to facilitate their intended operation. This significantly increases the operation and manufacturing costs as well as creating a higher probability of total failure of the valve. At the same time, a two-way valve is not able to maintain a low profile that is a desired characteristic for mobile inflatable devices such as outdoor inflatable mattresses.

It is therefore an object of the present invention to provide an improved valve that eliminates, or ameliorates at least in part, one or more of the aforementioned problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In a first aspect of the present invention there is an improved valve for an inflatable device comprising:
a valve port received within an aperture of the inflatable device;
a valve seat having fluid apertures provided therein; and
a diaphragm connected to the valve seat in a manner that occludes the fluid apertures when fluid is not forced therethrough,
   whereby, the improved valve may, at any time, be manipulated so as to physically remove the valve seat from the valve port to facilitate deflation of the inflatable device and physically insert the valve seat into the valve port to facilitate inflation of the inflatable device.

The valve seat may have first ribs provided on an external surface thereof, such that when the valve seat is inserted into the valve port, the first ribs create an interference fit between the valve seat and the valve port.

The improved valve may include a cap, the cap operable to act as a further seal for the valve. As with the valve seat, the cap may include second ribs provided on an external surface thereof, such that when the cap is inserted into the interior surface of the valve seat, the second ribs create an interference fit between the cap and the valve seat.

The valve seat and/or cap may have a tab extending therefrom. The purpose of the component from which the tab(s) extends may be identified by way of one or more of the following: colour; labels; visual texture; tactile texture.

The valve port is preferably connected to the valve seat by first connecting means in a manner that facilitates the valve seat to be inserted into the valve port. Similarly, the valve seat is preferably connected to the cap by second connecting means in a manner that facilitates the cap to be inserted into the valve seat. In either case, the connecting means may be one of the following: a flexible connector; a hinge, a cord; a two part construction where the parts are connected by mechanical means; a two part constructions where the parts are connected by magnetic means.

The valve seat may be further modified to facilitate the retention of an inflating aid.

Ideally the improved valve has a low profile. In its preferred form, the improved valve is somewhere between two and three centimeters in height when fully sealed.

### BRIEF DESCRIPTION OF THE DRAWINGS

The invention will now be described, by way of example only, with reference to the accompanying drawings, in which:

FIG. 1 is a cross-sectional view of an inflatable device incorporating an improved valve according to a first embodiment of the present invention.

FIG. 2 is an exploded view of the improved valve as shown in FIG. 1 in perspective view.

FIG. 3 is an exploded view of the improved valve as shown in FIG. 1 in plan view.

FIG. 4a is an exploded perspective view of the improved valve as show in FIG. 1 as configured for inflation.

FIG. 4b is a plan view of the same configuration in FIG. 4a.

FIG. 4c is an exploded perspective view of the improved valve as shown in FIG. 1 as configured for deflation.

FIG. 4d is a plan view of the same configuration of FIG. 4c.

FIG. 4e is an exploded perspective view of the improved valve as shown in FIG. 1 as configured for sealing.

FIG. 4f is a plan view of the same configuration of FIG. 4e.

FIGS. 5a through 5c are various views of an improved valve according to a second embodiment of the present invention.

FIGS. 6a through 6c are various views of an improved valve according to a third embodiment of the present invention.

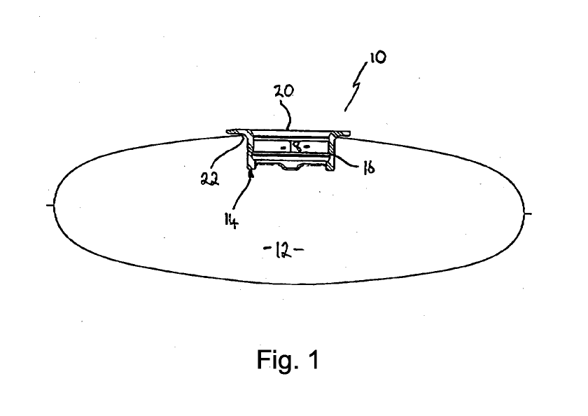

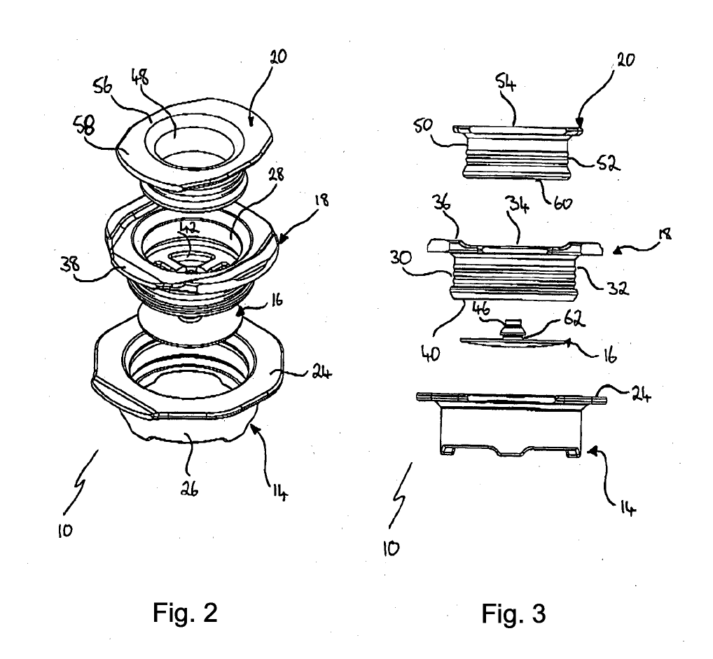

### PREFERRED EMBODIMENTS OF THE INVENTION

In accordance with a first embodiment of the invention there is an improved valve 10 for inflatable devices 12 comprising:

a valve port 14;

a diaphragm 16;

a valve seat 18; and

a cap 20.

The inflatable device 12 has an inflatable compartment. An opening 22 is provided in the inflatable compartment. The opening 22 operates to receive the valve port 14.

The valve port 14 comprises a flange 24 and a body 26. The body 26 takes the form of a squat hollow cylinder. The flange 24 extends from the circumference of one end of the body 26.

Following receipt of the valve port 14 within the opening 24 at the time of manufacture, the material from which the inflatable compartment 22 is made is welded to the flange 24. Once welded, the flange 24 operates to conceal and protect the weld.

The valve seat 18 is cylindrical in shape and has an interior profile 28 and an exterior profile 30. The exterior profile 30 has a plurality of ribs 32 provided thereon. The ribs 32 operate to generate an interference fit between the valve seat 18 and the valve port 14 when received therein.

One end 34 of the valve seat 18 is open. Extending from the open end 34 is a removal flange 36. A first tab 38 protrudes radially from the removal flange 36.

The other end 40 of the valve seat 18 has four apertures 42 of equal size and shape provided therein. A fifth circular aperture 44 is also provided in the valve seat 18 at a central position relative to the four apertures 42.

The diaphragm 16 is disc shaped and made from a flexible material. Extending centrally from the diaphragm 16 is a locating projection 46. The locating projection 46 is dimensioned so as to fit within circular aperture 44 and when so fitted, securely retain the diaphragm 16 to the valve seat 18.

The size of the diaphragm 16 is such that, when retained to the valve seat 18, the diaphragm 16 closes off the four apertures 42 in their entirety.

The cap 20 also is cylindrical in shape with an interior profile 48 and an exterior profile 50. The exterior profile 50 has a plurality of ribs 52 provided thereon. The ribs 52 operate to generate an interference fit between the cap 20 and valve seat 18 when received therein.

One end 54 of the cap 20 is open. Extending from the open end 54 is a cap flange 56. Extending from the cap flange 56 is a second tab 58.

The other end 60 of the cap 20 is closed. End 60, as projects towards the interior profile 48, is spherical.

This embodiment will now be described in the context of its intended use.

As indicated above, during manufacture of the improved valve 10 the valve port 14 is welded to the inflatable compartment. Also as part of the manufacturing process, the diaphragm 16 is installed into the valve seat 18.

Installation of the diaphragm 16 into the valve seat 18 is achieved by inserting the locating projection 46 through the circular aperture 44. Due to the presence of notch 62 in the diaphragm 16, as the locating projection 46 is inserted it deforms. This deformation continues until the locating projection 46 has been inserted to the position of notch 62. Once the locating projection 46 has been inserted to the position of notch 62, the portion of the locating projection 46 already inserted through the circular aperture 44 resumes its original form. This creates a configuration whereby the end 40 of the valve seat 18 about the position of the circular aperture 44 is sandwiched between the locating projection 46 and the remainder of the diaphragm 16.

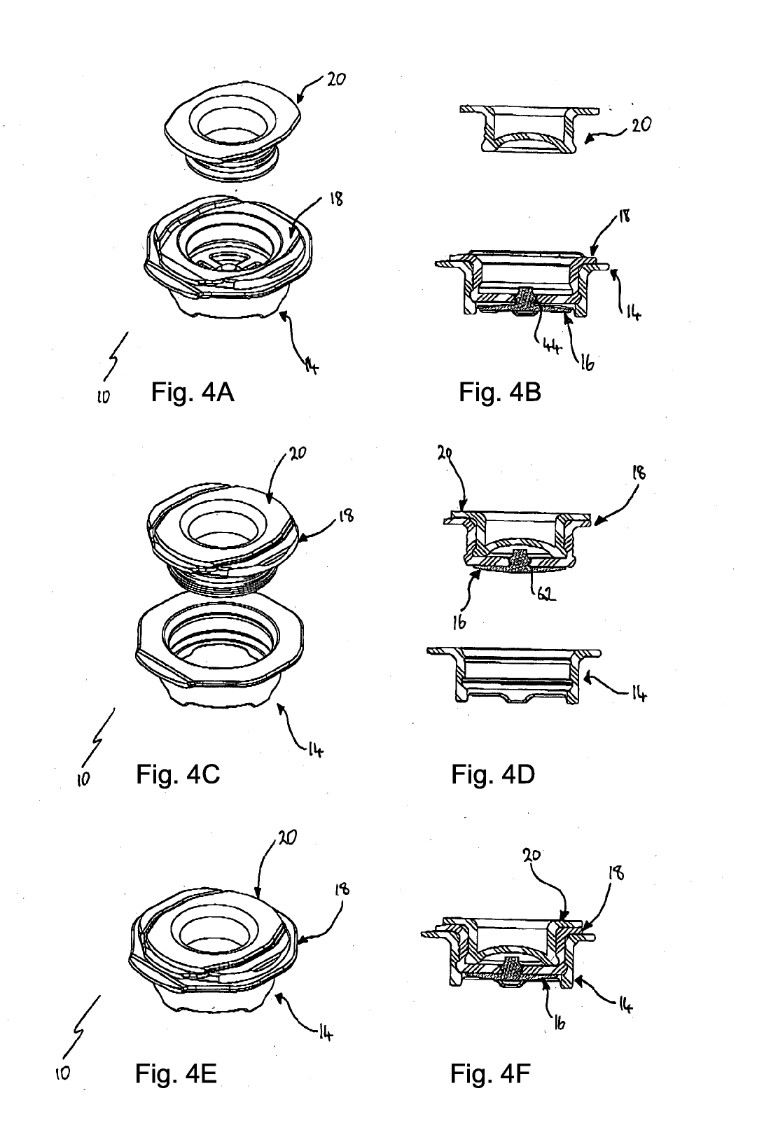

As manufactured, and also as required to facilitate sustained inflation of the inflatable compartment, the valve seat 18 is inserted into the valve port 14 such that the diaphragm 16 is encircled by the valve port 14 (see FIG. 4f). The interference fit formed between the valve port 14 and the exterior profile 30 of the valve seat 18 forms a seal between the two. This seal is able to withstand the pressure of the fluid in the inflatable compartment to a required pre-determined functional magnitude.

The cap 20 is also inserted into the valve seat 18. Again the interference fit formed between the exterior profile 50 of the cap 20 and the interior profile 28 of the valve seat 18 secures this connection.

To inflate the inflatable compartment, the cap 20 is removed. This is achieved by either hooking a finger into the interior profile 48 of the cap 20 and pulling or by leveraging the second tab 58. In either case, the force applied to the cap 20 breaks the interference fit formed between the cap 20 and the valve seat 18 and allows the cap 20 to be removed.

With the cap 20 removed a user can then force air through the improved valve 10 using any manner as would be readily known to the person skilled in the art. Forcing air through the improved valve 10 causes base portion 64 of the diaphragm 16 to deform as shown in FIG. 4b. In this deformed state, the diaphragm 16, no longer closes off the four apertures 42 in their entirety—thus allowing the forced air to pass through and inflate the inflatable compartment.

At the same time, as soon as there is a cessation in air being forced through the improved valve 10 the diaphragm 16 returns to its original position again closing off all four apertures 42 in their entirety. This thereby prevents the air already entered into the inflatable compartment from exiting the improved valve 10.

To deflate the inflatable compartment, the valve seat 18 is removed from the valve port 14 (either with or without the cap 20 connected). Removal is generally achieved by leveraging first tab 38. As before, the force applied to the valve seat 18 by way of the leverage of first tab 38 breaks the interference fit formed between the valve seat 18 and the valve port 14 and allows the valve seat 18 to be removed.

With the valve seat 18 removed, air contained within the inflatable compartment is then free to exit by way of the open valve port 14.

In accordance with a second embodiment of the invention, where like numerals reference like parts, there is an improved valve 100. The improved valve 100 is identical to improved valve 10 save for the following modifications.

Valve port 14 and valve seat 18 are connected by way of a first flexible connector 102. Flexible connector 102 is connected to side of valve seat 18 opposite first tab 38.

Valve seat 18 and cap 20 are connected by way of a second flexible connector 104. Flexible connector 104 is connected to the valve seat 18 at a position between the point of connection of the flexible connector 102 and the first tab 38. Flexible connector 104 is connected to the cap 20 at a position opposite second tab 58.

Manufacture of the improved valve 100 is done on the same principles as described above, but as would be modified by the person skilled in the art to incorporate the flexible connectors 102, 104.

In use, the improved valve 100 operates substantially as described above. However, to inflate the inflatable compartment, the cap 20 is removed by leveraging second tab 58. The leveraged force applied to the cap 20 by way of second tab 58 breaks the interference fit formed between the cap 20 and the valve seat 18 and allows the cap 20 to be removed.

While the interference fit between the cap 20 and the valve seat 18 is broken, the cap 20 remains connected to the valve seat 18 by way of flexible connector 104.

With the interference fit connection between cap 20 and valve seat 18 broken and the cap 20 removed from the valve seat 18, a user can then force air through the improved valve 10 using any manner as would be readily known to the person skilled in the art. Forcing air through the improved valve 100 causes base portion 64 of the diaphragm 16 to deform as shown in FIG. 4b. In this deformed state, the diaphragm 16, no longer closes off the four apertures 42 in their entirety—thus allowing the forced air to pass through and inflate the inflatable compartment.

At the same time, as soon as there is a cessation in air being forced through the improved valve 100 the diaphragm 16 returns to its original position again closing off all four apertures 42 in their entirety. This thereby prevents the air already entered into the inflatable compartment from exiting the improved valve 100.

Once the desired level of inflation has been achieved, cap 20 is re-inserted into the valve seat 18 by appropriate manipulation of the flexible connector 104. This re-establishes the interference fit between the cap 20 and the valve seat 18 thereby secures the improved valve 100.

To deflate the inflatable compartment 22, the valve seat 18 is removed from the valve port 14 (either with or without the cap 20 connected). Removal is achieved by leveraging first tab 38. As before, the force applied to the valve seat 18 by way of the leverage of first tab 38 breaks the interference fit formed between the valve seat 18 and the valve port 14 and allows the valve seat 18 to be removed.

As before, while the interference fit between the valve seat 18 and the valve port 14 is broken, the valve seat 18 remains connected to the valve port 14 by way of flexible connector 102.

With the interference fit between the valve seat 18 and the valve port 14 broken and the valve seat 18 removed from the valve port 14, air contained within the inflatable compartment is then free to exit by way of the open valve port 14.

As would be readily apparent to the person skilled in the art each of the above embodiments produces an improved valve of low profile. Hence allowing the inflatable device as a whole to be far more compressed than such devices incorporating existing valve structures.

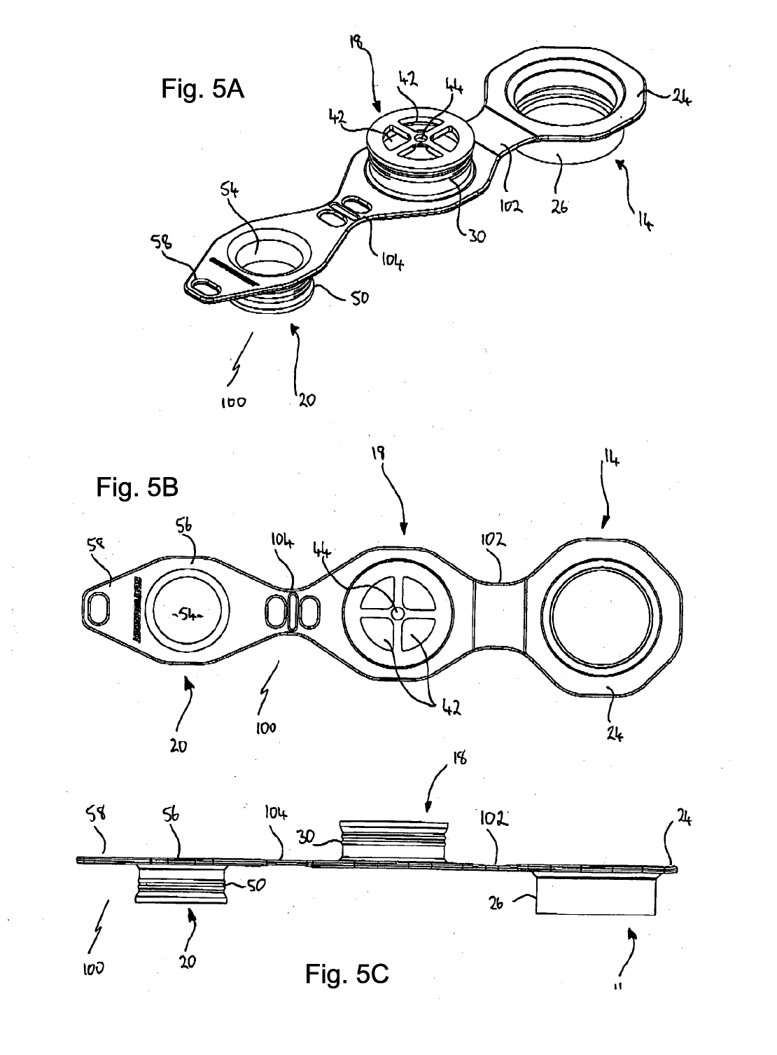

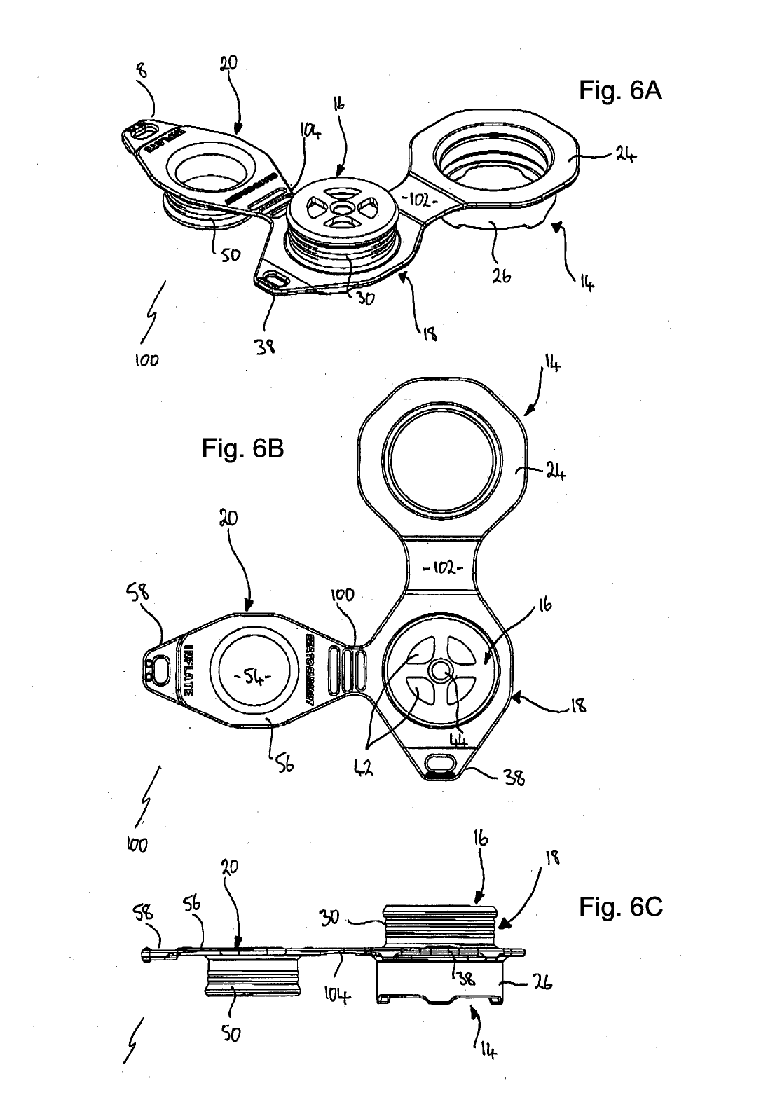

It should also be appreciated by the person skilled in the art that the above invention is not limited to the embodiment described. In particular, the following modifications and improvements may be made without departing from the scope of the present invention:
In a variation of the second embodiment, first tab 38 may be omitted. Ideally, flexible connector 102 is reconfigured to be attached to the valve seat 18 at the position otherwise to be occupied by first tab 38. A representation of this variant is shown here as FIGS. 5a through 5c. Use of this variant allows the user to apply leverage solely to the second tab 58 to break the interference fit between the cap 20 and the valve seat 18 and the interference fit between the valve seat 18 and the valve port 16.
The first tab 38 and/or the second tab 58 can be modified to facilitate easy identification of the inflate/deflate functions. Modifications in this vein may take the form of tabs 38, 58 of differing colours, appropriate labels on the tabs 38, 58 or tabs 38, 58 of differing textures for visual and/or tactile identification.
While the cap 20 plays an important role in further sealing the improved valve 10, 100 beyond the sealing function provided for by the diaphragm 16, it is not essential to the invention and may be omitted.
Other forms of securing the various components of the improved valve 10, 100 may be adopted in place of the ribs 32, 52 and interference fit arrangements they produce as described. For instance, one element may be provided with a male threaded portion and the other element provided with a mating female threaded portion.
Tab 38 may be omitted requiring the user to facilitate removal of the valve seat 18 by way of the removal flange 36. However, this is not preferable due to the difficulty this is likely to present to the user.
Similarly, tab 58 may be omitted requiring the user to facilitate removal of the cap 20 by way of the cap flange 56. Again, this is not preferable due to the difficulty this is likely to present to the user.
More or less apertures may be provided in the valve seat 18 than described.
The diaphragm 16 need not be positioned by way of notch 62, but may be positioned so as to occlude the apertures 42 through other means.
The valve seat 18 may be further modified to facilitate retention of an inflating aid. For instance, the interior profile 28 of valve seat 18 may have a lower portion adapted for the securing of the inflating aid and an upper portion having ribs 32 provided thereon for creating the described interference fit with the cap 20.
One or both of flexible connectors 102, 104 may be replaced with other arrangements. However, any such replacement must physically connect the two components that the replaced flexible connector 102, 104 otherwise joins and allows manipulation of those two components such that one may be inserted into the other. Accordingly, an arrangement such as a hinge may be used as a replacement for one or both flexible connector 102, 104.
The profile of the improved valve is preferably no greater than three centimeters in height when fully sealed, and, in its most preferred form, is no greater than two centimeters in height when fully sealed. In this context fully sealed means:
   where the embodiment incorporate cap 20, the insertion of the valve seat 18 (with cap 20) into the valve port 14; OR
   where the embodiments does not incorporate cap 20, the insertion of the valve seat 18 into the valve port 14.

It should be further appreciated by the person skilled in the art that the above variations and modifications, not being mutually exclusive, can be combined to form yet further embodiments that fall within the scope of the present invention.

What is claimed:

1. An improved valve for an inflatable device comprising:
a valve port received within an aperture of the inflatable device;
a valve seat having fluid apertures provided therein; and
a diaphragm connected to the valve seat in a manner that occludes the fluid apertures when fluid is not forced therethrough;
wherein the improved valve is configured, at any time, to be manipulated so as to physically remove the valve seat from the valve port to facilitate deflation of the inflatable device and physically insert the valve seat into the valve port to facilitate inflation of the inflatable device.

2. An improved valve according to claim 1, wherein the valve seat has first ribs provided on an external surface thereof, such that when the valve seat is inserted into the valve port, the first ribs create an interference fit between the valve seat and the valve port.

3. An improved valve according to claim 1, further comprising a cap, the cap operable to act as a further seal for the valve.

4. An improved valve according to claim 3, wherein the cap has second ribs provided on an external surface thereof, such that when the cap is inserted into the interior surface of the valve seat, the second ribs create an interference fit between the cap and the valve seat.

5. An improved valve according to claim 1, wherein the valve seat and/or cap has a tab extending therefrom.

6. An improved valve according to claim 5, wherein the purpose of the component from which the tab(s) extends is identified by way of one or more of the following: color; labels; visual texture; tactile texture.

7. An improved valve according to claim 1, wherein the valve port is connected to the valve seat by first connecting means in a manner that facilitates the valve seat to be inserted into the valve port.

8. An improved valve according to claim 7, further comprising a cap, the cap operable to act as a further seal for the valve.

9. An improved valve according to claim 8, wherein the valve seat is connected to the cap by second connecting means in a manner that facilitates the cap to be inserted into the valve seat.

10. An improved valve according to claim 7, wherein the connecting means is one of the following: a flexible connector, a hinge, a cord, a two part construction where the parts are connected by mechanical means, and a two part constructions where the parts are connected by magnetic means.

11. An improved valve according to claim 1, wherein the valve seat is further modified to facilitate the retention of an inflating aid.

12. An improved valve according to claim 1, wherein the improved valve has a low profile.

13. An improved valve according to claim 12, wherein the improved valve is no greater than three centimeters in height when fully sealed.

14. An improved valve according to claim 13, wherein the improved valve is no greater than two centimeters in height when fully sealed.
